(19) United States
(12) Patent Application Publication
(10) Pub. No.: US 2025/0133980 A1
(43) Pub. Date: May 1, 2025

(54) SYSTEM AND METHOD FOR DETECTING BENT SHAFTS OF DISK GANG ASSEMBLIES OF AN AGRICULTURAL IMPLEMENT

(71) Applicant: CNH Industrial America LLC, New Holland, PA (US)

(72) Inventor: Scott Glovier, McMurray, PA (US)

(21) Appl. No.: 18/494,916

(22) Filed: Oct. 26, 2023

(51) Int. Cl. A01B 79/00; A01B 35/28; A01B 71/04; G01P 3/00

(52) U.S. Cl. CPC A01B 79/00; A01B 35/28; A01B 71/04; G01P 3/00

(57) ABSTRACT

A system for detecting bent shafts of disk gang assemblies of an agricultural implement includes a disk gang assembly having a shaft, at least one bearing assembly rotatably supporting the shaft for rotation about a rotational axis, and a plurality of disks supported on the shaft for rotation about the rotational axis. The system further includes sensors associated with the disk gang assembly and configured to generate data indicative of a shaft-related parameter at two or more locations along the shaft. The system additionally includes a computing system configured to receive the data generated by each of the plurality of sensors and identify when the shaft is bent based at least in part on the data generated by each of the plurality of sensors.

### FIELD OF THE INVENTION

The present disclosure relates generally to agricultural implements and, more particularly, to systems and methods for detecting bent shafts of disk gang assemblies of an agricultural implement.

### BACKGROUND OF THE INVENTION

It is well known that, to attain the best agricultural performance from a field, a farmer must cultivate the soil, typically through a tillage operation. Modern farmers perform tillage operations by pulling a tillage implement behind an agricultural work vehicle, such as a tractor. Tillage implements typically include one or more tool assemblies configured to engage the soil as the implement is moved across the field. For example, in certain configurations, the implement may include one or more disk gang assemblies, leveling disk assemblies, rolling basket assemblies, shank assemblies, and/or the like. Such tool assemblies loosen and/or otherwise agitate the soil to prepare the field for subsequent planting operations.

Rotating tool assemblies, such as disk gang assemblies, leveling disk assemblies, and the like, may be supported on a common shaft for rotation as the implement moves through the field. The common shaft may be straight and freely spinning at the beginning of its operating life, however, if the tools attached to the common shaft strike a large obstacle, the shaft may bend. When the shaft bends, the penetration depth and the angle of attack of the tools is not consistent along the shaft, which can affect the quality of the tillage operation, and even subsequent yields. Moreover, the shaft may be more resistant to spinning, which may result in bearing failures. As such, the tool assembly associated with the shaft may be rendered ineffective or unsuitable for performing its intended function. However, it may be difficult for the operator to determine when shaft bending has occurred, especially during operation of the tillage implement.

Accordingly, systems and methods for detecting bent shafts of disk gang assemblies associated with an agricultural implement would be welcomed in the technology.

### BRIEF DESCRIPTION OF THE INVENTION

Aspects and advantages of the invention will be set forth in part in the following description, or may be obvious from the description, or may be learned through practice of the invention.

In one aspect, the present subject matter is directed to a system for detecting bent shafts of disk gang assemblies of an agricultural implement. The system may include a disk gang assembly having a shaft, at least one bearing assembly rotatably supporting the shaft for rotation about a rotational axis, and a plurality of disks supported on the shaft for rotation about the rotational axis. The system may further include a plurality of sensors associated with the disk gang assembly. The plurality of sensors may be configured to generate data indicative of a shaft-related parameter at two or more locations along the shaft, where the two or more locations may include a first location and a second location spaced apart from the first location. The system may additionally include a computing system configured to receive the data generated by each of the plurality of sensors and identify when the shaft is bent based at least in part on the data generated by each of the plurality of sensors.

In another aspect, the present subject matter is directed to a method for detecting when a shaft of a disk gang assembly of an agricultural implement is bent, where the disk gang assembly may include at least one bearing assembly rotatably supporting the shaft for rotation about a rotational axis and a plurality of disks supported on the shaft for rotation with the shaft about the rotational axis. The method may include receiving, with a computing system, data indicative of a shaft-related parameter at two or more locations along the shaft, with the two or more locations including a first location and a second location spaced apart from the first location. The method may further include identifying, with the computing system, when the shaft is bent based at least in part on the data indicative of the shaft-related parameter. Additionally, the method may include performing, with the computing system, a control action associated with the agricultural implement when the shaft is identified as being bent.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 illustrates a perspective view of one embodiment of an agricultural implement in accordance with aspects of the present subject matter, particularly illustrating the implement being towed by a work vehicle;

FIG. 2 illustrates another perspective view of the agricultural implement shown in FIG. 1 in accordance with aspects of the present subject matter;

FIG. 3 illustrates a perspective view of a ganged tool assembly of the implement in accordance with aspects of the present subject matter, particularly illustrating the ganged tool assembly configured as a disk gang assembly of the tillage implement;

FIG. 4 illustrates a partially exploded, perspective view of a support assembly for supporting the disk gang assembly of FIG. 3 in accordance with aspects of the present subject matter;

FIG. 5 illustrates a schematic view of a system for detecting bent shafts of disk gang assemblies of an agricultural implement in accordance with aspects of the present subject matter;

FIG. 6 illustrates example data plots showing a plot of monitored load in a time domain, and plots of both the magnitude and phase angle of the load data converted to a frequency domain, particularly illustrating an example in which the disk gang assembly is experiencing a bent shaft condition in accordance with aspects of the present subject matter; and

FIG. 7 illustrates a flow diagram of one embodiment of a method for detecting bent shafts of disk gang assemblies of an agricultural implement in accordance with aspects of the present subject matter.

Repeat use of reference characters in the present specification and drawings is intended to represent the same or analogous features or elements of the present technology.

### DETAILED DESCRIPTION OF THE INVENTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

In this document, relational terms, such as first and second, top and bottom, and the like, are used solely to distinguish one entity or action from another entity or action, without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises . . . a” does not, without more constraints, preclude the existence of additional identical elements in the process, method, article, or apparatus that comprises the element.

As used herein, the terms “first,” “second,” and “third” may be used interchangeably to distinguish one component from another and are not intended to signify a location or importance of the individual components. The terms “coupled,” “fixed,” “attached to,” and the like refer to both direct coupling, fixing, or attaching, as well as indirect coupling, fixing, or attaching through one or more intermediate components or features, unless otherwise specified herein. The term “selectively” refers to a component's ability to operate in various states (e.g., an ON state and an OFF state) based on manual and/or automatic control of the component.

Furthermore, any arrangement of components to achieve the same functionality is effectively “associated” such that the functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected” or “operably coupled” to each other to achieve the desired functionality, and any two components capable of being so associated can also be viewed as being “operably couplable” to each other to achieve the desired functionality. Some examples of operably couplable include, but are not limited to, physically mateable, physically interacting components, wirelessly interactable, wirelessly interacting components, logically interacting, and/or logically interactable components.

The singular forms “a,” “an,” and “the” include plural references unless the context clearly dictates otherwise.

Approximating language, as used herein throughout the specification and claims, is applied to modify any quantitative representation that could permissibly vary without resulting in a change in the basic function to which it is related. Accordingly, a value modified by a term or terms, such as “about,” “approximately,” “generally,” and “substantially,” is not to be limited to the precise value specified. In at least some instances, the approximating language may correspond to the precision of an instrument for measuring the value, or the precision of the methods or apparatus for constructing or manufacturing the components and/or systems. For example, the approximating language may refer to being within a ten percent margin.

Moreover, the technology of the present application will be described in relation to exemplary embodiments. The word “exemplary” is used herein to mean “serving as an example, instance, or illustration.” Any embodiment described herein as “exemplary” is not necessarily to be construed as preferred or advantageous over other embodiments. Additionally, unless specifically identified otherwise, all embodiments described herein will be considered exemplary.

As used herein, the term “and/or,” when used in a list of two or more items, means that any one of the listed items can be employed by itself, or any combination of two or more of the listed items can be employed. For example, if a composition or assembly is described as containing components A, B, and/or C, the composition or assembly can contain A alone; B alone; C alone; A and B in combination; A and C in combination; B and C in combination; or A, B, and C in combination.

In general, the present subject matter is directed to systems and methods for detecting bent shafts of disk gang assemblies of an agricultural implement. In several embodiments, a computing system may be configured to monitor a shaft-related parameter at multiple locations along the length of the shaft, where such parameter varies as a function of a condition of the shaft (e.g., unbent to bent), thereby allowing the computing system to determine or infer when the monitored shaft is bent. For instance, in one embodiment, the shaft-related parameter may be a load monitored at two or more locations spaced apart along the shaft, where the computing system is configured to analyze the load data to determine when the shaft is likely bent. For example, the computing system may perform a spectral analysis technique (e.g., Fourier transform) on the load data associated with each of the two or more locations to more easily identify when the shaft is bent. Generally, when the shaft is not bent, the magnitude of the load will be consistent along the disk gang shaft and the loads acting on the shaft will act essentially simultaneously (e.g., the difference in phase angle between loads at the different locations along the shaft is essentially zero). However, when the shaft is bent, the magnitude of the load will increase where the shaft is bent and the load at the bend will occur offset from the load at other locations along the shaft. As such, the computing system may determine that the shaft is bent when the magnitude of the load detected at the rotational frequency for at least one of the two or more locations is greater than a threshold magnitude and/or when the phase at the rotational frequency for at least one of the two or more locations differs from another of the two or more locations by a minimum phase angle (e.g., more than 0 degrees). Upon making such a determination, the computing system may be configured to automatically initiate a control action, such as by generating an operator notification and/or automatically adjusting the operation of the implement.

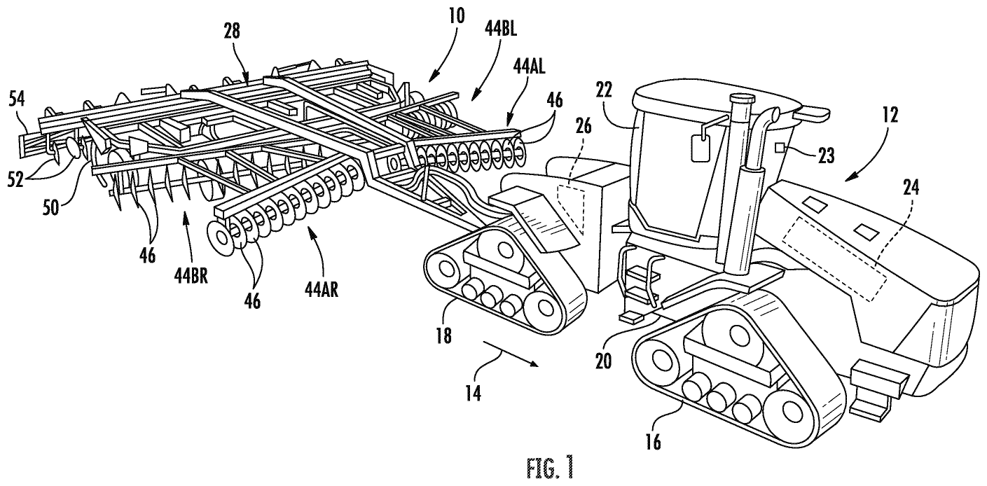

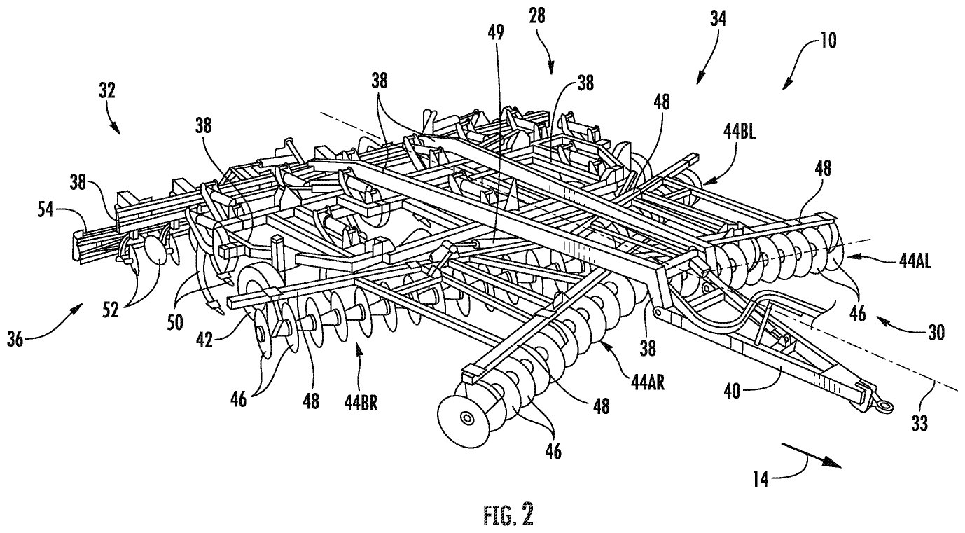

Referring now to the drawings, FIGS. 1 and 2 illustrate differing perspective views of one embodiment of an agricultural implement 10 in accordance with aspects of the present subject matter. Specifically, FIG. 1 illustrates a perspective view of the agricultural implement 10 coupled to a work vehicle 12. Additionally, FIG. 2 illustrates a perspective view of the implement 10, particularly illustrating various components of the implement 10.

In general, the implement 10 may be configured to be towed across a field in a direction of travel (e.g., as indicated by arrow 14 in FIG. 1) by the work vehicle 12. As shown, the implement 10 may be configured as a tillage implement, and the work vehicle 12 may be configured as an agricultural tractor. In other embodiments, the work vehicle 12 may be configured as any other suitable type of vehicle, such as an agricultural harvester, a self-propelled sprayer, and/or the like.

As shown in FIG. 1, the work vehicle 12 may include a pair of front track assemblies 16, a pair of rear track assemblies 18, and a frame or chassis 20 coupled to and supported by the track assemblies 16, 18. Alternatively, the track assemblies 16, 18 can be replaced with tires or any other suitable traction members. An operator's cab 22 may be supported by a portion of the chassis 20 and may house various input devices (e.g., a user interface 23) for permitting an operator to control the operation of one or more components of the work vehicle 12 and/or one or more components of the implement 10. Additionally, as is generally understood, the work vehicle 12 may include an engine 24 and a transmission 26 mounted on the chassis 20. The transmission 26 may be operably coupled to the engine 24 and may provide variably adjusted gear ratios for transferring engine power to the track assemblies 16, 18 via a drive axle assembly (not shown) (or via axles if multiple drive axles are employed).

As shown in FIGS. 1 and 2, the implement 10 may include a frame 28. More specifically, as shown in FIG. 2, the frame 28 may extend longitudinally between a forward end 30 and an aft end 32. The frame 28 may also extend laterally between a first lateral side 34 (e.g., a left side of the implement 10) and a second lateral side 36 (e.g., a right side of the implement 10), with a longitudinal centerline 33 of the implement frame 28 extending in the longitudinal direction between the forward and aft ends 30, 32 and generally dividing the first lateral side 34 from the second lateral side 36. In this respect, the frame 28 generally includes a plurality of structural frame members 38, such as beams, bars, and/or the like, configured to support or couple to a plurality of components. Furthermore, a hitch assembly 40 may be connected to the frame 28 and configured to couple the implement 10 to the work vehicle 12. Additionally, a plurality of wheels 42 (one is shown in FIG. 2) may be coupled to the frame 28 to facilitate towing the implement 10 in the direction of travel 14.

In several embodiments, the frame 28 may be configured to support one or more disk gang assemblies 44. As illustrated in FIG. 2, each disk gang assembly 44 includes a toolbar 48 coupled to the implement frame 28 and a plurality of harrow disks 46 supported by the toolbar 48 relative to the implement frame 28. Each harrow disk 46 may, in turn, be configured to penetrate into or otherwise engage the soil as the implement 10 is being pulled through the field. As is generally understood, the various disk gang assemblies 44 may be oriented at an angle relative to the direction of travel 14 to promote more effective tilling of the soil. In the embodiment shown in FIGS. 1 and 2, the implement 10 includes four disk gang assemblies 44 supported relative to the frame 28 at a location forward of the remainder of the ground-engaging tools. Specifically, the implement 10 includes a pair of front disk gang assemblies 44A (e.g., a left front disk gang assembly 44AL and a right front disk gang assembly 44AR) and a pair of rear disk gang assemblies 44B (e.g., a left rear disk gang assembly 44BL and a right rear disk gang assembly 44BR) positioned aft or rearward of the front disk gang assemblies 44A relative to the direction of travel 14 of the implement 10, with the left-side disk gang assemblies 44AL, 44BL being positioned on the left or first lateral side 34 of the implement 10 and the right-side disk gang assemblies 44AR, 44BR being positioned on the right or second lateral side 36 of the implement 10. It should be appreciated that, in alternative embodiments, the implement 10 may include any other suitable number of disk gang assemblies 44, such as more or less than four disk gang assemblies 44. Furthermore, in one embodiment, the disk gang assemblies 44 may be mounted to the frame 28 at any other suitable location, such as adjacent to its aft end 32. Moreover, the implement 10 may include one or more actuator(s) 49 (only one of which is shown) for adjusting the position of the toolbar(s) 48 relative to the frame 28 to adjust a penetration depth of the disks 46.

Additionally, as shown, in one embodiment, the implement frame 28 may be configured to support other ground-engaging tool assemblies. In the illustrated embodiment, the frame 28 is also configured to support one or more finishing tool assemblies, such as a plurality of leveler disk assemblies 52 and/or rolling (or crumbler) basket assemblies 54. However, in other embodiments, any other suitable ground-engaging tool assemblies may be coupled to and supported by the implement frame 28, such as a plurality of closing disks.

It should be appreciated that the configuration of the implement 10 described above and shown in FIGS. 1 and 2 is provided only to place the present subject matter in an exemplary field of use. Thus, it should be appreciated that the present subject matter may be readily adaptable to any manner of implement configurations.

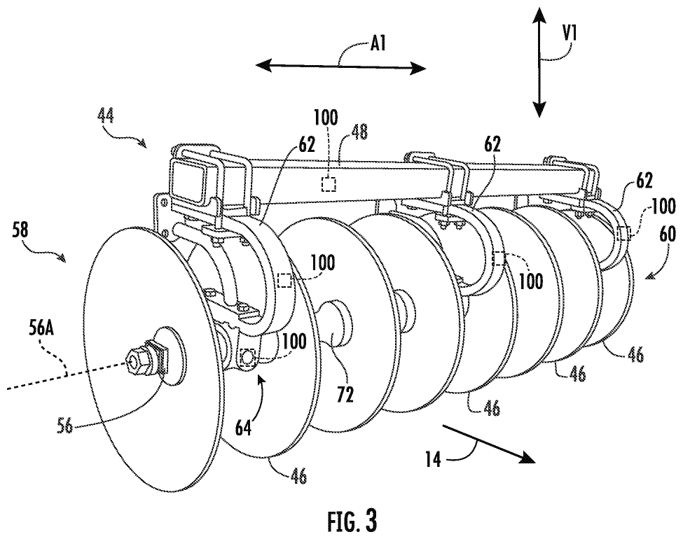

Referring now to FIG. 3, one example implementation of a disk gang assembly 44 described above in reference to FIGS. 1 and 2 is illustrated in accordance with aspects of the present subject matter. Specifically, FIG. 3 illustrates a perspective view of various components of the disk gang assemblies 44 of the implement 10 described above with reference to FIGS. 1 and 2. However, it should be appreciated that the aspects of disk gang assembly 44 described herein with reference to FIG. 3 may also be utilized with any other ganged tool assembly including any other suitable ground engaging tools of a given agricultural implement 10, such as individually mounted disks.

As shown in FIG. 3, the disk gang assembly 44 may include a plurality of disk blades 46 spaced apart along the length of a disk gang shaft 56 extending along an axial direction A1 between a first end 58 and a second end 60. The disk blades 46 (alternatively referred to herein as “disks 46”) are generally configured to rotate about an axis 56A defined by the shaft 56. In one embodiment, the disks 46 are “keyed” to the shaft 56 such that all of the disks 46 rotate together about the axis 56A with the shaft 56. However, in other embodiments, the disks 46 may be allowed to rotate independently about the axis 56A relative to the shaft 56. The disk gang assembly 44 may also include a plurality of spools 72 positioned on the gang shaft 56, with each spool 72 extending axially between a pair of adjacent disks 46. For instance, each disk 46 is spaced apart from an adjacent disk 46 in the axial direction A1 via a respective spool 72 extending therebetween along the adjacent axial section of the gang shaft 56. As a result, an open space is defined between each pair of adjacent disks 46 in the axial direction A1 via the spacing provided by the associated spool 72.

The disk gang shaft 56 may be coupled to the toolbar 48 of the disk gang assembly 44 via one or more support assemblies such that the disk gang shaft 56 is positioned vertically below the toolbar 48 along a vertical direction (e.g., as indicated by arrow V1). For instance, each of the support assemblies includes a hanger 62 coupled at one end to the toolbar 48 and at the opposite end to the disk gang shaft 56. Specifically, in some embodiments, the hanger 62 is coupled to the disk gang shaft 56 by a bearing 64 supporting the disk gang shaft 56 for rotation.

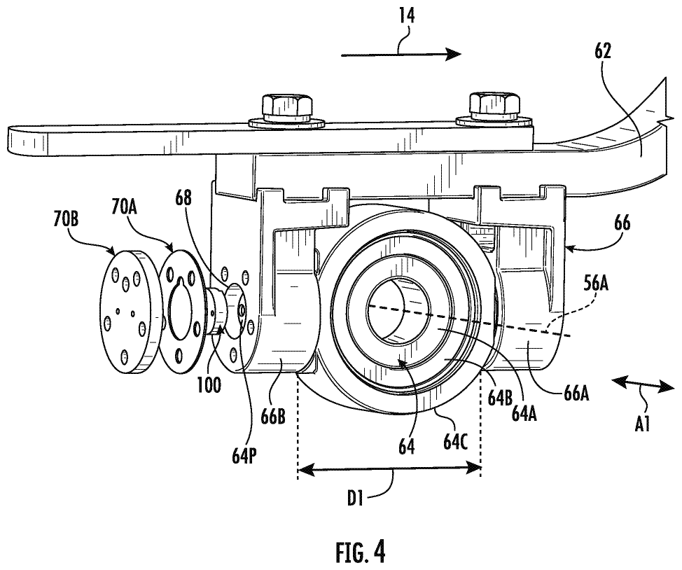

For example, as shown in FIG. 4, the bearing 64 may be supported by a support mount 66 relative to the hanger 62. More particularly, the support mount 66 may include a first mounting portion 66A and a second mounting portion 66B spaced apart in a direction D1 (e.g., where the direction D1 is perpendicular to the axis 56A of the disk gang shaft 56). In some instances, the first mounting portion 66A is forward of the second mounting portion 66B along the direction of travel 14. In one embodiment, such as the embodiment shown, the first and second mounting portions 66A, 66B are discrete parts, separately coupled to the hanger 62 by fastening elements (e.g., screws, bolts, rivets, etc.) or by any other means (e.g., welding, soldering, etc.). However, it should be appreciated that, in other embodiments, the first and second mounting portions 66A, 66B are portions of a unitary part which is coupled to the hanger 62. It should additionally be appreciated that, in one embodiment, the first and second mounting portions 66A, 66B collectively define or form a trunnion mount.

The bearing 64 may include an inner race 64A configured to receive, and be rotatably fixed to, the disk gang shaft 56 (FIG. 3) for rotation about the shaft axis 56A. The inner race 64A may be rotatably received within, and configured to be rotatable relative to, an outer race 64B. The outer race 64B may, in turn, be coupled to the mounting portions 66A, 66B such that the outer race 64B is held against rotation about the axis 56A. For instance, the outer race 64B may be received within, and rotatably fixed to, a mount 64C. The mount 64C may have a protrusion 64P extending outwardly from each of the forward end and the rearward end (only the protrusion 64P at the rearward end being shown) along the direction D1 for receipt within a respective opening 68 in the mounting portions 66A, 66B (only the opening 68 in the second mounting portion 66B being shown). It should be appreciated, however, that the mount 64C may instead be integral with the outer race 64B of the bearing 64.

Referring back to FIG. 3, in the illustrated embodiment, each of the hangers 62 defines a C-shape that permits the disk gang shaft 56 and the disk blades 46 mounted thereon to move relative to the toolbar 48. However, it should be appreciated that, in alternative embodiments, the hanger(s) 62 may have any other suitable configuration. It should additionally be appreciated that while the disk gang assembly 44 is shown as having three support assemblies in FIG. 3, the disk gang assembly 44 may have any other suitable number of support assemblies, such as two, four, five or more support assemblies.

With the disk gang assembly 44 positioned at its lowered or working position, the disks 46 of the assembly 44 may be configured to penetrate a soil surface of the field and rotate about the respective rotational axis 56A relative to the soil within the field as the implement 10 is moved across a field. The bearings 64 and the shaft 56 of the disk gang assembly 44 are typically subject to varying loading conditions, particularly as the disks 46 encounter differing soil conditions and objects within the soil (e.g., rocks, roots, etc.). If the disks 46 hit a particularly hard or large obstacle, the shaft 56 may bend. When the shaft 56 bends, the disks 46 closer to the bend may penetrate more deeply into the field than the disks 46 further from the bend. Moreover, the loads closer to the bend in the shaft 56 may act on the shaft 56 offset from areas further from the bend (e.g., with the same rotational frequency of the shaft, but with a different period). As such, by monitoring a shaft-related parameter (e.g., the load(s)) at different locations along the shaft during the performance of a tillage operation, it may be inferred or determined when the shaft is significantly bent.

Thus, as will be described below in greater detail, the shaft-related parameter(s) associated with a shaft 56 of a given disk assembly 44 may be monitored using two or more bending sensors 100 provided in operative association with the disk assembly 43. For instance, as shown in FIG. 3, a bending sensor 100 may be provided in association with at least two or more of the bearings 64 to monitor the draft load at each of the associated bearings. In some instances, the bending sensors 100 are provided in association with each of the bearings 64. The bending sensors 100 may be in contact with the bearings 64 and/or on the hangers 62 supporting such bearings 64.

For example, in one embodiment, as shown in FIG. 3, the bending sensors 100 may be at least partially received within one or both of the opening(s) 68, between the protrusion 64P of the mount 64C and one or more retention plates 70A, 70B. In such embodiment, as the disks 46 move through a field, the bearing 64 may experience loads that cause the mount 64C to move along the direction D1. As such, the bending sensor(s) 100 within the opening(s) 68 may be configured to monitor the portion of the load acting along the direction D1. For instance, in some embodiments, the bending sensor(s) 100 within the opening(s) 68 directly contacts the respective protrusion 64P to detect the load on the bearing 64. It should be appreciated that, in such embodiments, the bending sensors 100 may be configured as any suitable type of draft load sensors. For instance, the bending sensors 100 may be a load cell, a force transducer, and/or the like.

It should be appreciated that, when one or more of the bending sensors 100 is alternatively, or additionally, provided in association with the hanger(s) 62, such bending sensor(s) 100 may correspond to any suitable draft load sensor configured to directly or indirectly monitor the load, such as an accelerometer, an inertial measure unit (IMU), a strain gauge, and/or the like. Additionally, it should be appreciated that the bending sensor(s) 100 may be positioned at any other suitable location to generate data indicative of the shaft-related parameter.

It should be appreciated that, when the shaft-related parameter is monitored at only two locations along the shaft 56, the two locations preferably include a location closer to or at a center of the shaft 56 (e.g., at the center hanger 62 and/or center bearing 64) and another location closer to an end of the shaft 56 (e.g., at the inner/outer hanger 62 and/or inner/outer bearing 64). For instance, if the shaft-related parameter was measured only at the inner and outer hangers 62, then it may be difficult to determine when the shaft 56 is bent at the center of the shaft 56, as the readings at the inner and outer hangers 62 may be substantially the same.

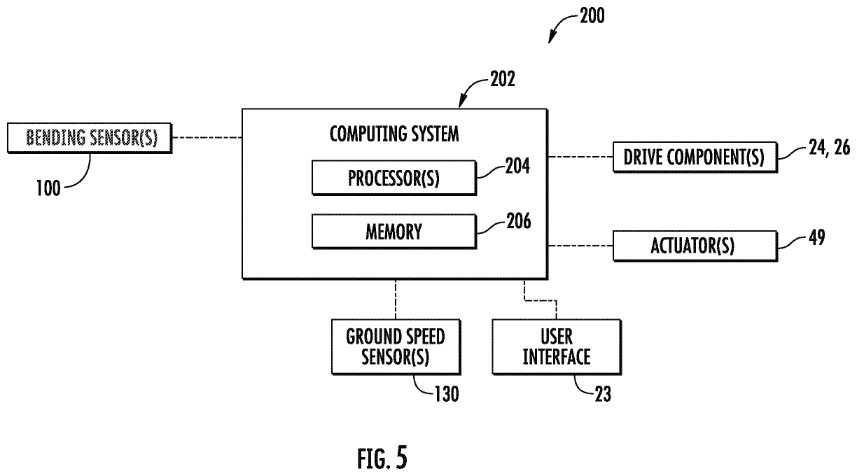

Referring now to FIG. 5, a schematic view of one embodiment of a system 200 for detecting bent shafts of disk gang assemblies of an agricultural implement is illustrated in accordance with aspects of the present subject matter. In general, the system 200 will be described herein with reference to the implement 10 and related disk gang assemblies 44 described above with reference to FIGS. 1-4. However, it should be appreciated by those of ordinary skill in the art that the disclosed system 200 may generally be utilized with agricultural implements having any other suitable implement configuration and/or with disk gang assemblies having any other suitable gang configuration. Additionally, although the system 200 will generally be described with reference to disk gang assemblies, the system 200 may generally be used to detect bearing failures associated with any other tool assemblies that include or incorporate bearings, such as basket assemblies, leveler disk assemblies, and/or any other suitable rotating tool assemblies.

In general, the system 200 may include, or be in communication with, one or more components of an agricultural implement, such as one or more of the components of the implement 10 described above. For example, as shown in FIG. 5, the system 200 may include one or more bending sensors (e.g., the bending sensors 100 described above) configured to provide data indicative of one or more shaft-related parameters associated with the shaft 56. Further, the system 200 may be in communication with implement actuators, such as the actuator(s) 49 for adjusting the penetration depth of the associated disk gang assembly(ies) 44. Furthermore, the system 200 may be in communication with one or more drive component(s) of a work vehicle towing the implement, such as the engine 24 and/or transmission 26 of the work vehicle 12. Moreover, the system 200 may be in communication with a user interface, such as the user interface 23. It should be appreciated that the user interface(s) 23 may include one or more feedback devices (not shown), such as display screens, speakers, warning lights, and/or the like. In addition, some embodiments of the user interface(s) 23 may include one or more input devices (not shown), such as touchscreens, keypads, touchpads, knobs, buttons, sliders, switches, mice, microphones, and/or the like, for allowing an operator to provide inputs to the system 200. Additionally, the system 200 may be in communication with one or more ground speed sensors, such as ground speed sensor(s) 130 configured to generate data indicative of the ground speed of the implement 10. In one embodiment, the ground speed sensor 130 may correspond to a GPS device or any other suitable satellite navigation position system configured to generate data associated with the ground speed of the implement 10. In another embodiment, the ground speed sensor(s) 130 may correspond to a rotary speed sensor(s) configured to monitor the rotational speed of a given component that provides an indication of the ground speed of the implement 10, such as the engine 24 or transmission 26 of the work vehicle 12 or a wheel of the vehicle 12 or implement 10.

In accordance with aspects of the present subject matter, the system 200 may also include a computing system 202 configured to execute various computer-implemented functions. In general, the computing system 202 may comprise any suitable processor-based device known in the art, such as a computing device or any suitable combination of computing devices. Thus, in several embodiments, the computing system 202 may include one or more processor(s) 204 and associated memory device(s) 206 configured to perform a variety of computer-implemented functions. As used herein, the term “processor” refers not only to integrated circuits referred to in the art as being included in a computer, but also refers to a controller, a microcontroller, a microcomputer, a programmable logic controller (PLC), an application specific integrated circuit, and other programmable circuits. Additionally, the memory device(s) 206 of the computing system 202 may generally comprise memory element(s) including, but not limited to, a computer readable medium (e.g., random access memory (RAM)), a computer readable non-volatile medium (e.g., a flash memory), a floppy disk, a compact disc-read only memory (CD-ROM), a magneto-optical disk (MOD), a digital versatile disc (DVD) and/or other suitable memory elements. Such memory device(s) 206 may generally be configured to store suitable computer-readable instructions that, when implemented by the processor(s) 204, configure the computing system 202 to perform various computer-implemented functions, such as one or more aspects of the methods or algorithms described herein. In addition, the computing system 202 may also include various other suitable components, such as a communications circuit or module, one or more input/output channels, a data/control bus and/or the like.

It should be appreciated that the computing system 202 may correspond to an existing computing system of the implement 10 or associated work vehicle 12 or the computing system 202 may correspond to a separate computing system. For instance, in one embodiment, the computing system 202 may form all or part of a separate plug-in module that may be installed in association with the implement 10 or work vehicle 12 to allow for the disclosed system 200 and related methods to be implemented without requiring additional software to be uploaded onto existing computing systems of the implement 10 and/or the work vehicle 12.

In several embodiments, the computing system 202 may be configured to monitor one or more shaft-related parameters (e.g., load) associated with the shaft 56 of one or more disk gang assemblies 44 of an agricultural implement 10 to determine when the shaft(s) 56 is likely bent. Specifically, in one embodiment, the computing system 202 may be communicatively coupled to the bending sensors 100 (e.g., via a wired or wireless connection) to receive the data generated by the bending sensors 100 indicative of the shaft-related parameter (e.g., load) over a period of time and identify based on the data generated by the bending sensors 100 when the shaft is bent.

In general, the spatial (time) domain data generated by the bending sensors 100 may be noisy, which may make it difficult to identify cyclical loads due to bending from cyclical loads due to other conditions, such as engine cycling related ground speed oscillations, lateral seesawing of the disk gang assembly 44, C-hanger spring oscillations, down-pressure spring oscillations, and/or the like. As such, in some embodiments, the computing system 202 may analyze the data generated by the bending sensors 100 using one or more spectral analysis techniques to more easily identify the presence of shaft bending from other influences during the implement 10 operation. For instance, the computing system 202 may convert the data generated by each of the bending sensors 100 from the spatial (time) domain to the frequency domain using a spectral analysis technique, which makes it easier to identify cyclical frequencies. It should be appreciated that any suitable Fourier transformation technique, such as a Fast Fourier, Cooley-Tukey, Prime Factor, Bruun's, Rader's, Bluestein's, and/or Hexagonal techniques, or any other suitable spectral analysis techniques, such as the Bartlett's, Welch's, and/or Least-squares techniques, may be used to analyze the data generated by the bending sensors 100.

Generally, when the data is transformed from the spatial domain to the frequency domain, a complex number is provided for each of the monitored locations along the shaft 56, where the complex number has a real part (i.e., magnitude) and an imaginary part (i.e., phase angle). As such, in some embodiments, the computing system 202 may compare the magnitudes and/or the phase angles of the transformed data at a rotational frequency of the disks 46 for the two or more locations along the shaft 56 and identify whether the shaft 56 is bent based on such comparisons. In one embodiment, the computing system 202 may estimate or measure the rotational frequency of the disks 46 based at least in part on the ground speed of the implement 10. However, it should be appreciated that, in some embodiments, the rotational frequency may additionally, or alternatively, be determined in any other suitable manner, such as by using a rotational speed sensor connected to the shaft 56, and/or the like.

For example, in some instances, the computing system 202 may compare the magnitude at the detected rotational frequency of the disks 46 associated with the shaft 56 in the transformed data for each location along the shaft 56 to a baseline or maximum magnitude (e.g., as determined when the disk gang shaft 56 was known to be straight or unbent) to determine if the shaft 56 is bent. If the magnitude of the load at the rotational frequency of the disk gang assembly 44 at least at one of the monitored locations along the shaft 56 (e.g., proximate the center hanger 62) exceeds the maximum magnitude by a least a given difference, but not for at least one of the other monitored locations along the shaft 56 (e.g., proximate the inner or outer hanger 62), then the computing system 202 may determine that it is likely that the shaft 56 is bent proximate the location(s) along the shaft that exceeds the threshold by the given difference. The given difference may be, for example, about 10 or more, such as about 20, such as about 30, and/or the like. However, it should be appreciated that any suitable given threshold difference may be used. Moreover, it should be appreciated that, in some instances, the computing system 202 may compare the magnitude at the rotational frequency of the disks 46 associated with the shaft 56 to more than one baseline magnitude, where the different baseline magnitudes may be associated with different severities of the shaft-bending condition (e.g., slightly bent condition, moderately bent condition, severely bent condition, and/or the like).

It should additionally be appreciated that the magnitudes at the two or more locations could instead, or additionally, be directly compared to each other. For instance, if the magnitude at one location at the rotational frequency of the disk gang assembly 44 was greater than the magnitude of at least one other location by a given amount, then it could be determined that the shaft 56 may be bent at such location. It should further be appreciated that, in some instances, the computing system 202 may additionally, or alternatively, monitor the change in magnitude over time to determine or confirm shaft bending. For instance, if the magnitude at one or more locations increases to above the magnitude threshold(s) suddenly (e.g., within a few seconds), the computing system 202 may determine that the shaft 56 has suddenly bent (e.g., due to hitting an obstacle), instead of a typically more gradual bearing failure.

In one or more embodiments, the computing system 202 may additionally, or alternatively, compare the phase angle of the transformed data at the rotational frequency of the disks 46 for each location along the shaft 56 to identify whether the shaft 56 is bent. For example, the computing system 202 may determine that the shaft 56 is bent when the phase angle at the rotational frequency of the disks 46 for at least one monitored location (e.g., proximate the center hanger 62) is offset by a minimum angle (e.g., by a minimum degree when the phase angle is in degrees or by minimum radians when the phase angle is in radians) from the phase angle at the rotational frequency of the disks 46 of at least one other location (e.g., proximate the inner or outer hanger 62). Particularly, the minimum angle is non-zero. For instance, the loading at the bend in the shaft 56 may be offset, opposite from loading where the shaft is less bent or not bent, such that the minimum degree may be about 180 degrees (e.g., π radians).

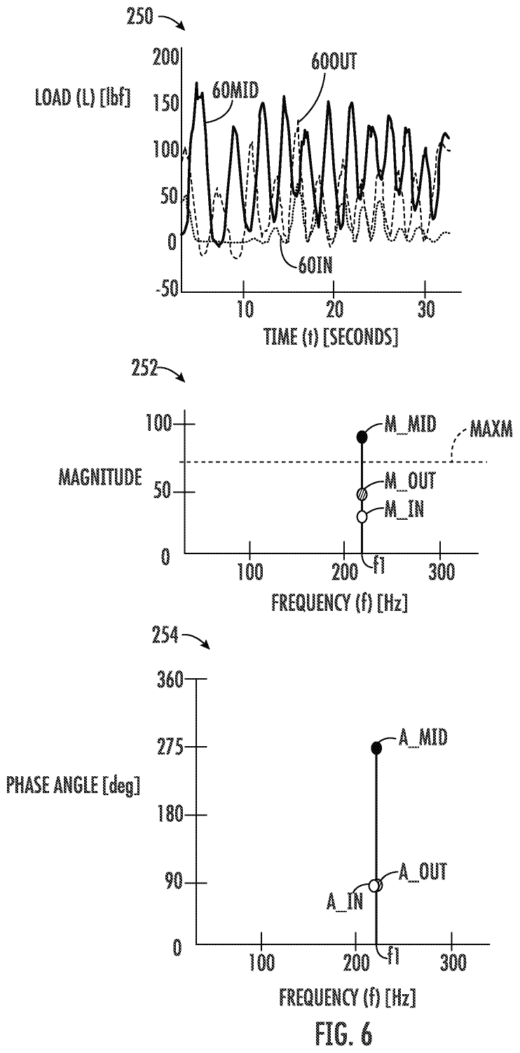

As an example of such analysis, FIG. 6 illustrates example data plots showing an example in which a disk gang assembly 44 is experiencing a bent shaft condition in accordance with aspects of the present subject matter. More particularly, the top plot 250 in FIG. 6 illustrates the monitored load over time at three different locations along the shaft 56 of one disk gang assembly 44 (e.g., the load 60IN measured at the inner hanger 62, the load 60MID measured at the middle hanger 62, and the load 60OUT measured at the outer hanger 62 relative to a lateral center of the implement 10). Moreover, the middle plot 252 in FIG. 6 illustrates the time domain data from the plot 250 converted using a Fast Fourier Transformation (FFT) technique into the frequency domain, particularly illustrating the magnitude of the loading at the rotational frequency f1 of the monitored disk gang assembly 44 (e.g., at about 230 Hz) at the three different locations along the shaft 56 (e.g., the magnitude M_IN of cyclical loading at the inner hanger 62, the magnitude M_MID of cyclical loading at the middle hanger 62, and the magnitude M_OUT of cyclical loading at the outer hanger 62 relative to a lateral center of the implement 10). Additionally, the bottom plot 254 in FIG. 6 illustrates the time domain data from the plot 250 converted using a Fast Fourier Transformation (FFT) technique into the frequency domain, particularly illustrating the phase angle of the loading at the rotational frequency f1 of the monitored disk gang assembly 44 (e.g., at about 230 Hz) at the three different locations along the shaft 56 (e.g., the phase angle A_IN of cyclical loading at the inner hanger 62, the phase angle A_MID of cyclical loading at the middle hanger 62, and the phase angle A_OUT of cyclical loading at the outer hanger 62 relative to a lateral center of the implement 10). It should be appreciated that in some instances, there may be significant magnitudes at other frequencies, but the magnitude at the rotational frequency (e.g., at about 230 Hz) and multiples of the rotational frequency (e.g., 460 Hz, 690 Hz, and/or the like) are analyzed for bending in this example.

As shown in the plot 250, the load 60MID measured at the middle hanger 62 is typically greater than the load 60OUT measured at the outer hanger 62, and the load 60OUT measured at the outer hanger 62 is typically greater than the load 60IN measured at the inner hanger 62. However, it is difficult to determine from the plot 250 if the disk gang 44 is just unevenly leveled from inner end to outer end.

From the plot 252, the computing system 202 may determine that the monitored shaft 56 is likely bent as the magnitude M_MID (e.g., equal to about 90) associated with the center hanger 62 at the rotational frequency f1 exceeds the threshold magnitude MAXM (e.g., equal to about 70) by at least a given amount (e.g., by more than 10), while the magnitudes M_IN, M_OUT (e.g., equal to about 30 and 45, respectively) associated with the inner and outer hangers 62 at the rotational frequency f1 do not exceed the threshold magnitude MAXM (e.g., equal to about 70). Moreover, the magnitude M_MID associated with the center hanger 62 is significantly different (e.g., by 40 or more) from the magnitudes M_IN, M_OUT associated with the inner and outer hangers 62. As such, the computing system 202 may additionally determine that the shaft 56 is likely bent into a v or u-shape.

Moreover, from the plot 254, the computing system 202 may additionally, or alternatively, determine that the monitored shaft 56 is likely bent as the phase angle A_MID (e.g., equal to about 270 degrees) associated with the center hanger 62 at the rotational frequency f1 is offset by the minimum degree (e.g., about 180 degrees) from the phase angle(s) A_IN, A_OUT (e.g., each being equal to about 90 degrees) associated with the inner and outer hangers 62 at the rotational frequency f1. As such, the computing system 202 may determine that the shaft 56 is likely bent into a v or u-shape.

It should be appreciated that by using both the comparison of magnitude and the comparison of phase angle it may be more positively determined or confirmed that the shaft 56 is bent, instead of another failure condition, such as a failed bearing.

Referring back to FIG. 5, when the computing system 202 determines that the monitored shaft(s) 56 is bent, the computing system 202 is configured to automatically perform one or more control actions associated with the agricultural implement 10. For instance, in one embodiment, the control action may include the computing system 202 controlling an operation of the user interface(s) 23 to indicate that the shaft(s) 56 is bent (e.g., by causing a visual or audible notification or indicator to be presented). Similarly, in one or more embodiments, the control action may include the computing system 202 being configured to additionally, or alternatively, control an operation of the actuator(s) 49 to change (e.g., reduce) a penetration depth of the disk gang assembly (ies) 44 having the bent shaft(s) 56. In some embodiments, the control action may include the computing system 202 being configured to additionally, or alternatively, control an operation of the drive component(s) 24, 26 of the work vehicle 12 to slow down or stop the implement 10 and vehicle 12.

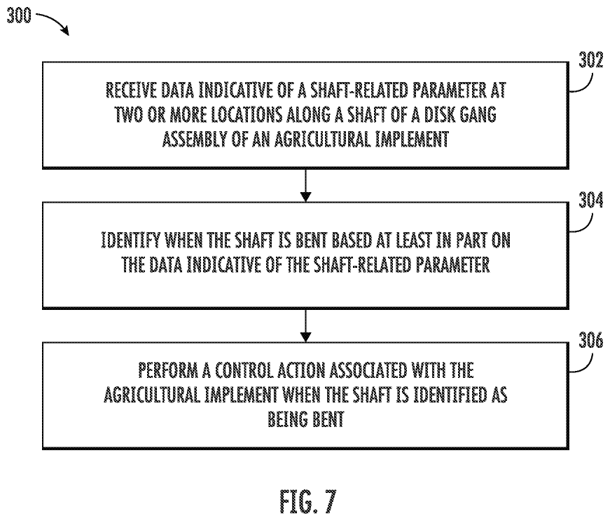

Referring now to FIG. 7, a flow diagram of one embodiment of a method 300 for detecting bent shafts of disk gang assemblies of an agricultural implement is illustrated in accordance with aspects of the present subject matter. In general, the method 300 will be described herein with reference to the agricultural implement 10 and the disk gang assemblies 44 described above with reference to FIGS. 1-4, and the system 200 described above with reference to FIGS. 5-6. However, it should be appreciated by those of ordinary skill in the art that the disclosed method 300 may generally be utilized in association with agricultural implements having any suitable implement configuration, tool assemblies having any other suitable tool configuration and/or systems having any other suitable system configuration. In addition, although FIG. 7 depicts steps performed in a particular order for purposes of illustration and discussion, the methods discussed herein are not limited to any particular order or arrangement. One skilled in the art, using the disclosures provided herein, will appreciate that various steps of the methods disclosed herein can be omitted, rearranged, combined, and/or adapted in various ways without deviating from the scope of the present disclosure.

As shown in FIG. 7, at (302), the method 300 may include receiving data indicative of a shaft-related parameter at two or more locations along a shaft of a disk gang assembly of an agricultural implement. For instance, as described above, the computing system 202 may receive the data generated by the bending sensor(s) 100 indicative of a shaft-related parameter (e.g., load) at two or more locations along the shaft 56 of a given disk gang assembly 44 of the agricultural implement 10, where the two locations are spaced apart. For example, one of the locations may be proximate to the center of the shaft 56 and the other location may be closer to an end of the shaft 56 than the center.

Further, at (304), the method 300 may include identifying when the shaft is bent based at least in part on the data indicative of the shaft-related parameter. For example, as discussed above, the computing system 202 may identify when the shaft 56 of the given disk gang assembly 44 is bent based at least in part on the data indicative of the shaft-related parameter from the sensor(s) 100. For instance, the computing system 202 may monitor the magnitudes and/or the phase angle of the loads at the two or more locations to identify when the shaft 56 is bent.

Additionally, at (306), the method 300 may include performing a control action associated with the agricultural implement when the shaft is identified as being bent. For instance, as discussed above, the computing system 202 may perform a control action associated with the agricultural implement 10 when the shaft 56 is identified as being bent, such as controlling an operation of the user interface(s) 23, an operation of the actuator(s) 49 for the given disk gang assembly (ies) 44, an operation of the drive component(s) 24, 26, and/or the like, when the shaft 56 is identified as being bent.

It is to be understood that the steps of the method 300 are performed by the computing system 202 upon loading and executing software code or instructions which are tangibly stored on a tangible computer readable medium, such as on a magnetic medium, e.g., a computer hard drive, an optical medium, e.g., an optical disk, solid-state memory, e.g., flash memory, or other storage media known in the art. Thus, any of the functionality performed by the computing system 202 described herein, such as the method 300, is implemented in software code or instructions which are tangibly stored on a tangible computer readable medium. The computing system 202 loads the software code or instructions via a direct interface with the computer readable medium or via a wired and/or wireless network. Upon loading and executing such software code or instructions by the computing system 202, the computing system 202 may perform any of the functionality of the computing system 202 described herein, including any steps of the method 300 described herein.

The term “software code” or “code” used herein refers to any instructions or set of instructions that influence the operation of a computer or computing system. They may exist in a computer-executable form, such as machine code, which is the set of instructions and data directly executed by a computer's central processing unit or by a computing system, a human-understandable form, such as source code, which may be compiled in order to be executed by a computer's central processing unit or by a computing system, or an intermediate form, such as object code, which is produced by a compiler. As used herein, the term “software code” or “code” also includes any human-understandable computer instructions or set of instructions, e.g., a script, that may be executed on the fly with the aid of an interpreter executed by a computer's central processing unit or by a computing system.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A system for detecting bent shafts of disk gang assemblies of an agricultural implement, the system comprising:
a disk gang assembly comprising:
a shaft;
at least one bearing assembly rotatably supporting the shaft for rotation about a rotational axis; and
a plurality of disks supported on the shaft for rotation about the rotational axis;
a plurality of sensors associated with the disk gang assembly, the plurality of sensors being configured to generate data indicative of a shaft-related parameter at two or more locations along the shaft, the two or more locations including a first location and a second location spaced apart from the first location; and
a computing system configured to:
receive the data generated by each of the plurality of sensors; and
identify when the shaft is bent based at least in part on the data generated by each of the plurality of sensors.

2. The system of claim 1, wherein the computing system is further configured to:
convert the data generated by each of the plurality of sensors from a time domain to a frequency domain using a spectral analysis technique; and
determine a magnitude and a phase angle at a rotational frequency of the shaft for each of the two or more locations along the shaft based at least in part on the data generated by each of the plurality of sensors converted to the frequency domain,
wherein the computing system is configured to identify when the shaft is bent based at least in part on a comparison of the magnitudes and the phase angles at the two or more locations along the shaft.

3. The system of claim 2, wherein the computing system is configured to identify that the shaft is bent when the magnitude at least at one of the two or more locations is greater than a threshold magnitude by at least a given difference.

4. The system of claim 2, wherein the computing system is configured to identify that the shaft is bent when the phase angle of the second location is offset by a minimum degree from the phase angle of the first location along the shaft.

5. The system of claim 4, wherein the minimum degree is about 180 degrees.

6. The system of claim 2, wherein the spectral analysis technique is Fourier transformation.

7. The system of claim 1, wherein the computing system is further configured to perform a control action when the shaft is identified as being bent.

8. The system of claim 1, wherein each of the plurality of sensors is a load sensor, the data being indicative of a load on the shaft.

9. The system of claim 1, wherein the at least one bearing assembly comprises at least a first bearing assembly at the first location and a second bearing assembly at the second location, a first sensor of the plurality of sensors being provided in association with the first bearing assembly and a second sensor of the plurality of sensors being provided in association with the second bearing assembly.

10. The system of claim 1, wherein the second location is at a center of the shaft.

11. The system of claim 1, wherein the two or more locations further includes a third location, the second location being between the first location and the second location.

12. A method for detecting when a shaft of a disk gang assembly of an agricultural implement is bent, the disk gang assembly comprising at least one bearing assembly rotatably supporting the shaft for rotation about a rotational axis and a plurality of disks supported on the shaft for rotation with the shaft about the rotational axis, the method comprising:
receiving, with a computing system, data indicative of a shaft-related parameter at two or more locations along the shaft, the two or more locations including a first location and a second location spaced apart from the first location;
identifying, with the computing system, when the shaft is bent based at least in part on the data indicative of the shaft-related parameter; and
performing, with the computing system, a control action associated with the agricultural implement when the shaft is identified as being bent.

13. The method of claim 12, further comprising:
converting, with the computing system, the data indicative of the shaft-related parameter at each of the two or more locations from a time domain to a frequency domain using a spectral analysis technique; and
determining, with the computing system, a magnitude and a phase angle at a rotational frequency of the shaft for each of the two or more locations along the shaft based at least in part on the data indicative of the shaft-related parameter at each of the two or more locations converted to the frequency domain,
wherein identifying when the shaft is bent comprises identifying when the shaft is bent based at least in part on a comparison of the magnitudes and the phase angles at the two or more locations along the shaft.

14. The method of claim 13, wherein identifying that the shaft is bent comprises identifying that the shaft is bent when the magnitude at least at one of the two or more locations is greater than a threshold magnitude by at least a given difference.

15. The method of claim 13, wherein identifying that the shaft is bent comprises identifying that the shaft is bent when the phase angle of the second location is offset by a minimum degree from the phase angle of the first location along the shaft.

16. The method of claim 13, wherein converting the data to the frequency domain using the spectral analysis technique comprises converting the data to the frequency domain using a Fourier transformation.

17. The method of claim 12, wherein performing the control action comprises controlling an operation of a user interface associated with the agricultural implement to indicate that the shaft is identified as being bent.

18. The method of claim 12, wherein performing the control action comprises automatically controlling an operation of the agricultural implement.

19. The method of claim 12, wherein receiving the data indicative of the shaft-related parameter at each of the two or more locations comprises receiving the data from a plurality of load sensors, the data being indicative of a load on the shaft at each of the two or more locations.

20. The method of claim 12, wherein receiving the data indicative of the shaft-related parameter at each of the two or more locations comprises receiving data generated by a first sensor provided in association with a first bearing assembly of the at least one bearing assembly at the first location and data generated by a second sensor provided in association with a second bearing assembly of the at least one bearing assembly at the second location.
